(19) United States
(12) Patent Application Publication
(10) Pub. No.: US 2012/0128386 A1
(43) Pub. Date: May 24, 2012

(54) IMAGE FORMING APPARATUS CONTROLLING OPERATION NOISE VOLUME

(75) Inventors: Yoshiki KATAYAMA, Toyokawa-shi (JP); Satoru Sasaki, Toyokawa-shi (JP); Natsuyo Higashi, Toyokawa-shi (JP); Shigetaka Kato, Shinshiro-shi (JP); Hirotada Seki, Toyokawa-shi (JP)

(73) Assignee: Konica Minolta Business Technologies, Inc., Chiyoda-ku (JP)

(21) Appl. No.: 13/297,825

(22) Filed: Nov. 16, 2011

(30) Foreign Application Priority Data
Nov. 18, 2010 (JP) 2010-257932

(51) Int. Cl. G03G 15/00

(52) U.S. Cl. 399/91

(57) ABSTRACT

An image forming apparatus has a moving part that operates for forming an image on recording paper. When an instruction to make a transition to a silent mode is input to an input unit, first control is executed so that operation noise of the moving part is reduced. When an instruction to cancel the silent mode is input to the input unit, second control is executed so that the operation noise of the moving part is increased stepwise to return to the state before the first control.

This application is based on Japanese Patent Application No. 2010-257932 filed with the Japan Patent Office on Nov. 18, 2010, the entire content of which is hereby incorporated by reference.

### BACKGROUND OF THE INVENTION

1. Field of the Invention

The present invention relates to an image forming apparatus and, more specifically, to an image forming apparatus that controls volume of operation noise.

2. Description of the Related Art

Conventionally, printers and copiers forming images on a recording medium have been known.

Among image forming apparatuses as represented by such printers and copiers, some form images on a recording medium by forming toner images, and heating and pressing the toner images by a fixing device on the recording medium. In an image forming apparatus of this type, various moving members such as a blower fan for dissipating heat generated from the fixing device to the outside of a housing through an outlet provided at a part of the housing of the apparatus and rollers for feeding sheets of recording paper are provided.

Recently, operation noise caused by the operations of these moving members arranged in the apparatus is regarded as a problematic source of noise in some situations. Various measures have been considered to solve this problem.

By way of example, Reference 1 (Japanese Laid-Open Patent Publication No. 2004-198889) discloses an image forming apparatus having two different operation modes of different volumes of operation noise. According to the disclosure, the image forming apparatus has a copy function and a print function, and in accordance with the function to be executed and on contents of settings in the apparatus, whether or not the operation is to be done in the mode of lower operation noise is determined. For example, the operation enters silent mode if the print function is to be executed and certain contents are set.

Further, Reference 2 (Japanese Laid-Open Patent Publication No. 2008-197252) discloses an image forming apparatus having two different operation modes of different volumes of operation noise, having a function of detecting environmental noise level. In the image forming apparatus, on condition that the volume of environmental noise becomes lower than a specific volume, operation is executed in the mode of lower operation noise.

In both of the conventional image forming apparatuses described above, when the operation returns from the mode of lower operation noise to the mode of higher operation noise, the volume of operation changes abruptly. Such an abrupt change annoys users near the image forming apparatus.

### SUMMARY OF THE INVENTION

The present invention was made in view of such a situation, and its object is to temporarily operate an image forming apparatus with reduced volume of operation noise, without annoying the users.

The present invention provides an image forming apparatus having a moving part operating for forming an image on a sheet of recording paper, including: an input unit giving an instruction to make a transition to a silent mode having operation noise by the moving part reduced, and an instruction to cancel the silent mode; and a control unit controlling operation of the moving part. The control unit executes, in response to an instruction to make a transition to the silent mode input from the input unit, first control of reducing operation noise of the moving part, and in response to an instruction to cancel the silent mode input from the input unit, executes second control of returning state of operation of the moving part to a state before the first control, with operation noise of the moving parts increased stepwise.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an image forming apparatus in accordance with an embodiment of the present invention.

FIG. 2 is a schematic block diagram of an image forming apparatus in accordance with an embodiment of the present invention.

FIG. 3 is an illustration of an operation display in accordance with an embodiment of the present invention.

FIG. 4 is a flowchart representing transition to a silent mode, in accordance with an embodiment of the present invention.

FIG. 5 is a flowchart representing a silent activation mode, in accordance with an embodiment of the present invention.

FIG. 6 is a flowchart representing a silent standby mode, in accordance with an embodiment of the present invention.

FIG. 7 is a flowchart representing a silent print mode, in accordance with an embodiment of the present invention.

FIG. 8 is another flowchart representing the silent print mode, in accordance with an embodiment of the present invention.

FIG. 9 is a still another flowchart representing the silent print mode, in accordance with an embodiment of the present invention.

FIG. 10 is a control block for controlling rollers, in accordance with an embodiment of the present invention.

FIGS. 11 and 12 are still further flowcharts representing the silent print mode, in accordance with an embodiment of the present invention.

FIG. 13 shows updating of a reservation table, in accordance with an embodiment of the present invention.

FIG. 14 shows a ranking table representing scores based on job types.

FIGS. 15A to 15C illustrate control of a correction roller for correcting deviation of sheet such as paper skew, in accordance with an embodiment of the present invention.

FIGS. 16 and 17 are still further flowcharts representing the silent print mode, in accordance with an embodiment of the present invention.

FIG. 18 is a flowchart representing a process for cancelling the silent mode, in accordance with an embodiment of the present invention.

FIGS. 19 to 22 are still further flowcharts representing the processes for cancelling the silent mode, in accordance with an embodiment of the present invention.

### DESCRIPTION OF THE PREFERRED EMBODIMENTS

In the following, embodiments of the present invention will be described with reference to the figures. In the following description, the same parts and components are denoted by the same reference characters. Their names and functions are also the same.

[1. Schematic Configuration of Image Forming Apparatus]

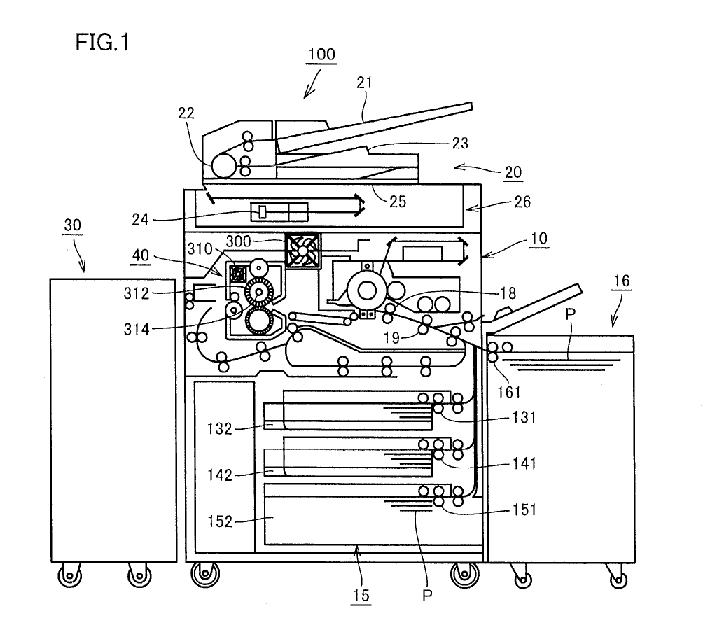

FIG. 1 shows a configuration of an image forming apparatus in accordance with an embodiment of the present invention.

Referring to FIG. 1, an image forming apparatus 100 is implemented as a copier, formed to include a plurality of moving parts. Specifically, image forming apparatus 100 includes: a document feeding unit 20 for feeding a document; an image reading unit 26 reading the fed document as image data; an image forming unit 10 for forming an image based on the read image data; paper feed units 15 and 16 for feeding sheets of recording paper; a fixing unit 40 for fixing an image transferred to a sheet of recording paper; and a post processing unit 30 for executing post processing on the sheets of recording paper. In image forming apparatus 100, a control unit for overall control, an input unit for inputting an instruction and the like are further provided. In addition, an internal fan 300 for decreasing temperature in the apparatus is also provided in image forming apparatus 100.

A document placed on a platen 21 of document feeding unit 20 is fed by a conveyer roller 22 or the like, read by image reading unit 26, and discharged to a discharge tray 23.

Further, a CCD (Charge Coupled Device) 24 on image reading unit 26 obtains, for example, the image data read from the document fed by document feeding unit 20, and outputs the data to control unit 50.

Image forming unit 10 has a photoreceptor as an image carrying body, a charger unit, an exposure unit, a developer, a transfer roller and the like, and it forms an image on a fed sheet of recording paper P and outputs the recorded sheet of recording paper P, of which image bearing surface is not yet fixed, to fixing unit 40. Though not shown in the present example, it is assumed that four developers are provided and using yellow, magenta, cyan and black, color printing is possible.

Fixing unit 40 executes a fixing process on the not-yet fixed recorded sheet of recording paper P. Fixing unit 40 includes a fan 310, a fixing roller 312, and a heater 314 provided in fixing roller 312.

The sheet of recording paper is discharged from fixing unit 40 to post processing unit 30 as needed, and at post processing unit 30, post processing such as punching, stapling or the like is executed.

Paper feed units 15 and 16 feed sheets of recording paper to image forming unit 10.

At paper feed unit 15, cassettes 132, 142 and 152 containing sheets of recording paper of different sizes are provided. Pick-up rollers 131, 141 and 151 are provided corresponding to cassettes 132, 142 and 152, respectively, each for feeding sheets of recording paper from the cassette to image forming unit 10. Further, sheets of recording paper are also fed from paper feed unit 16 through pick-up roller 161 to image forming unit 10. It is noted that sheets of recording paper are fed one by one from paper feed unit 15 or 16 to image forming unit 10.

Further, a correction roller for correcting deviation such as skew of the sheet is provided in image forming unit 10. This will be described later.

[2. Block Configuration of Image Forming Apparatus]

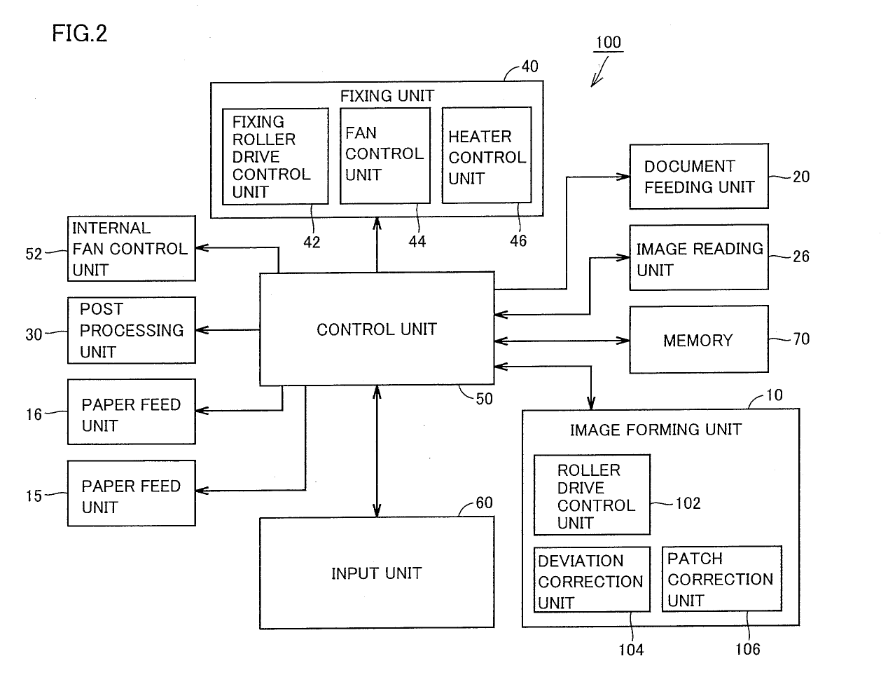

FIG. 2 is a schematic block diagram of image forming apparatus 100 in accordance with an embodiment of the present invention.

Referring to FIG. 2, the apparatus includes: control unit 50 for overall control of image forming apparatus 100; post processing unit 30 for executing post processing; paper feed units 15 and 16 for feeding sheets of recording paper; an input unit 60 including an operation display; image forming unit 10 for forming an image; a memory 70; image reading unit 26; document feeding unit 20; fixing unit 40; and an internal fan control unit 52 for controlling internal fan 300.

Control unit 50 is implemented, for example, by a CPU (Central Processing Unit), which reads various application programs stored in memory 70 and thereby controls various units.

Fixing unit 40 includes: a fixing roller drive control unit 42 for controlling driving of fixing roller 312; a fan control unit 44 for controlling fan 310 provided in fixing unit 40; and a heater control unit 46 for controlling heater 314.

Image forming unit 10 includes: a roller drive control unit 102 for driving various rollers for feeding sheets of recording paper; a deviation correction unit 104 for controlling the correction roller; and a patch correction unit 106 generating a pattern for detecting toner density, detecting the generated pattern and thereby executing patch correction for adjusting the toner density.

[3. Operation Display]

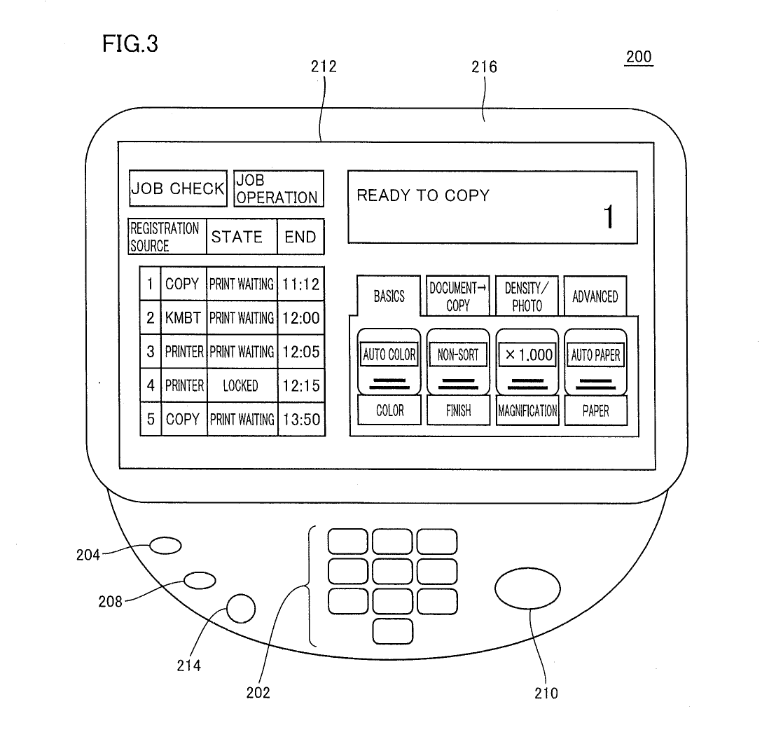

FIG. 3 illustrates operation display 200 in accordance with an embodiment of the present invention.

Referring to FIG. 3, operation display 200 includes a display unit 212, a collector microphone 204, an authentication sensor 208, a silent button 214, ten keys 202, and a start button 210.

On display unit 212, a touch-panel is provided, allowing prescribed operations on display unit 212.

Collector microphone 204 functions as a part of input unit, and it enables voice instruction.

Authentication sensor 208 reads data from a card key or the like and executes an authentication process. Not only the authentication using card key but also biometric authentication may be executed.

Silent button 214 is a button for realizing, in response to pressing of the button, the silent mode in accordance with the embodiment of the present invention as will be described later.

Ten keys 202 are buttons for inputting, for example, the number of copies. Start button 210 is for instructing execution of a process such as copying/scanning.

On display unit 212, various modes and the like are displayed. The touch-panel allows various settings in accordance with the displayed contents. By way of example, on display unit 212, normally, buttons for basic/advanced settings for copy and scan operations are arranged. When a button is pressed, a corresponding layer of screen image allowing detailed settings is displayed.

Further, on display unit 212, job information reserved in image forming apparatus 100 at that time point is displayed. Specifically, jobs to be executed are displayed in order of job IDs. If an operation such as erasure or change is to be made on a specific job, a job operation button is selected first, and then a job number button of the object of operation is pressed. By these operations, a job operation screen image is displayed, allowing an operation on the specific job.

[4. Transition to Silent Mode]

In the following, the silent mode in accordance with the present embodiment will be described.

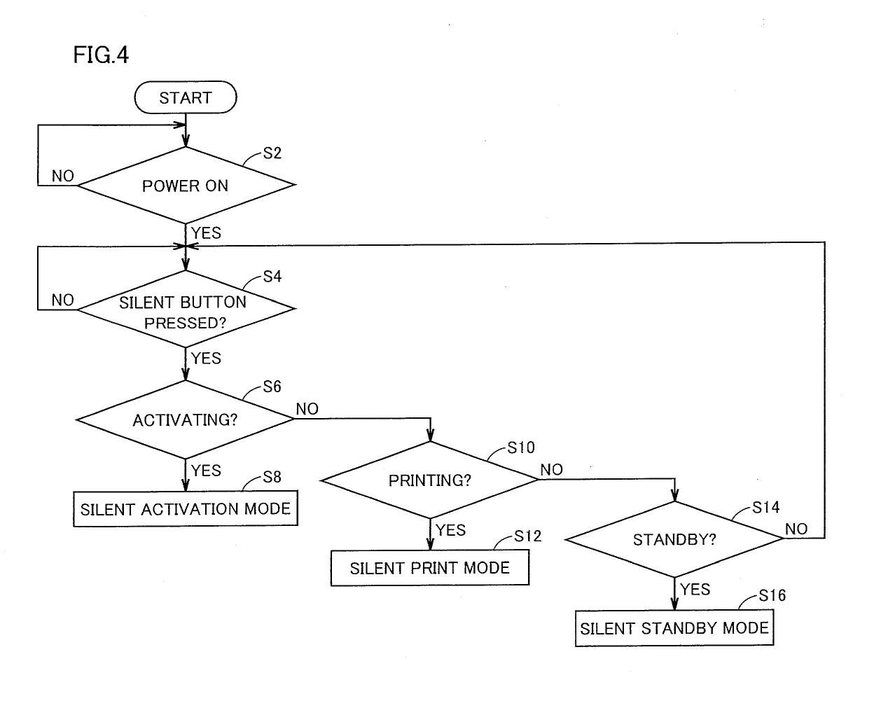

FIG. 4 is a flowchart representing the transition to the silent mode in accordance with the present embodiment. Specifically, the transition is realized by control unit 50 reading a program stored in memory 70.

Referring to FIG. 4, first, control unit 50 determines whether or not the power is turned ON (step S2).

Next, if it is determined that the power is ON (YES at step S2), control unit 50 determines whether or not the silent button is pressed (step S4). Specifically, whether or not silent button 214 on operation display 200 shown in FIG. 3 is pressed is determined. Here, if there is an input of silent button 214, control unit 50 determines in what state the image forming apparatus is in at the timing of input, and switches the silent mode in accordance with the state. By way of example, the operation is switched to any of three silent modes.

If it is determined that the silent button is pressed (YES at step S4), control unit 50 determines whether or not the apparatus is in an activating process (step S6). Immediately after power ON, generally, image forming apparatus 100 starts the activating process. As the activating process, an operation (initial operation) of determining whether or not various units operate normally is executed. For instance, at fixing unit 40, rotation of fixing roller 312 starts. Further, fan 310 provided in fixing unit 40 starts rotation. Further, power supply control to heater 314 provided in fixing unit 40 is executed. As the initial operation, prescribed operations for determining normal drive are executed at other portions.

If it is determined that the silent button has been input in the activation process (YES at step S6), control unit 50 makes a transition to silent activation mode (step S8). Details of the silent activation mode will be described later.

If it is determined at step S6 that the silent button has been input not during activation (NO at step S6), control unit 50 determines whether or not the silent button is input during a printing operation (step S10). “During a printing operation” means that image forming apparatus 100 is neither in the activating process nor in a standby state, and a process of image formation or the like is being in progress.

If it is determined that the silent button has been input during the printing operation (YES at step S10), control unit 50 makes a transition to a silent print mode. Details of the silent print mode will be described later.

Next, if it is determined at step S10 that the silent button has been input not during the printing operation (NO at step S10), control unit 50 determines whether or not the apparatus is in a standby state (step S14). If it is determined at step S14 that the silent button is input in the standby state (YES at step S14), control unit 50 makes a transition to a silent standby mode (step S16). Details of the silent standby mode will be described later.

If it is determined at step S14 that the silent button is input not in the standby state (NO at step N14), control unit 50 determines that the input is invalid, and the control returns to step S4.

[5. Silent Activation Mode]

FIG. 5 is a flowchart representing the silent activation mode in accordance with the present embodiment. Specifically, the mode is realized by control unit 50 reading a program stored in memory 70. Here, a process at fixing unit 40 as an example of a plurality of moving parts will be described.

Referring to FIG. 5, control unit 50 suspends rotation of fixing roller 312 in fixing unit 40 (step S20).

Thereafter, power supply to heater 314 provided in fixing unit 40 is also suspended (step S22).

Next, control unit 50 suspends rotation of fan 310 provided in fixing unit 40 (step S24).

Thereafter, control unit 50 determines whether or not silent button 214 is pressed again (step S26).

If it is determined at step S26 that silent button 214 is pressed again, suspension of various parts is cancelled and the silent mode is cancelled (step S28). Contents of the process for cancelling silent mode will be described later. Then, the process ends (END).

On the other hand, if silent button 214 is not pressed again, the state of step S26 is maintained.

In the silent activation mode, by suspending the initial operation in fixing unit 40, for example, the operation of fixing unit 40 as the source of noise at the time of activation is immediately stopped, so that the volume of operation noise is reduced and silent state is attained. The initial operation may be resumed by pressing silent button 214 again.

In the present embodiment, the operation noise represents the total sum of noise volumes generated by operations such as rotation of various elements such as a motor, rollers or a fan in image forming apparatus 100.

Though fixing unit 40 has been described here, the above-described control is similarly applicable to the initial operation of other units such as image forming unit 10.

[6. Silent Standby Mode]

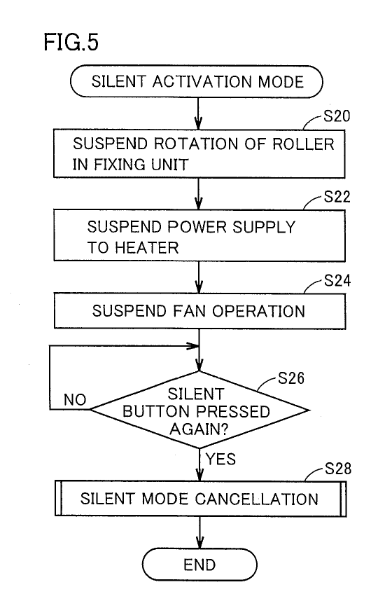

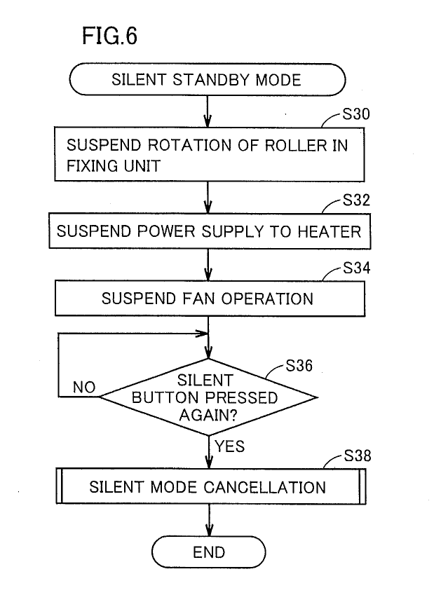

FIG. 6 is a flowchart representing the silent standby mode in accordance with the present embodiment. Specifically, the mode is realized by control unit 50 reading a program stored in memory 70. Here, a process at fixing unit 40 as an example of a plurality of moving parts will be described. In the standby state also, power supply control of heater 314 for controlling temperature of fixing unit 40, rotation of fixing roller 312 and rotation of fan 310 are being executed in fixing unit 40.

Referring to FIG. 6, control unit 50 suspends rotation of fixing roller 312 in fixing unit 40 (step S30).

Thereafter, power supply to heater 314 provided in fixing unit 40 is also suspended (step S32).

Next, control unit 50 suspends rotation of fan 310 provided in fixing unit 40 (step S34).

Thereafter, control unit 50 determines whether or not silent button 214 is pressed again (step S36).

If it is determined at step S36 that silent button 214 is pressed again, suspension of various parts is cancelled and the silent mode is cancelled (step S38). Contents of the process for cancelling silent mode will be described later. Then, the process ends (END).

On the other hand, if silent button 214 is not pressed again, the state of step S36 is maintained.

In the silent standby mode also, by suspending the initial operation in fixing unit 40, for example, the operation of fixing unit 40 as the source of noise at the time of standby is immediately stopped, so that the volume of operation noise is reduced and silent state is attained. Though all operations are suspended in the example described above, it is not limiting. What is required is to suspend operation of at least one member as a source of noise and, by way of example, only the rotation of fixing roller 312 may be stopped.

[7. Silent Print Mode]

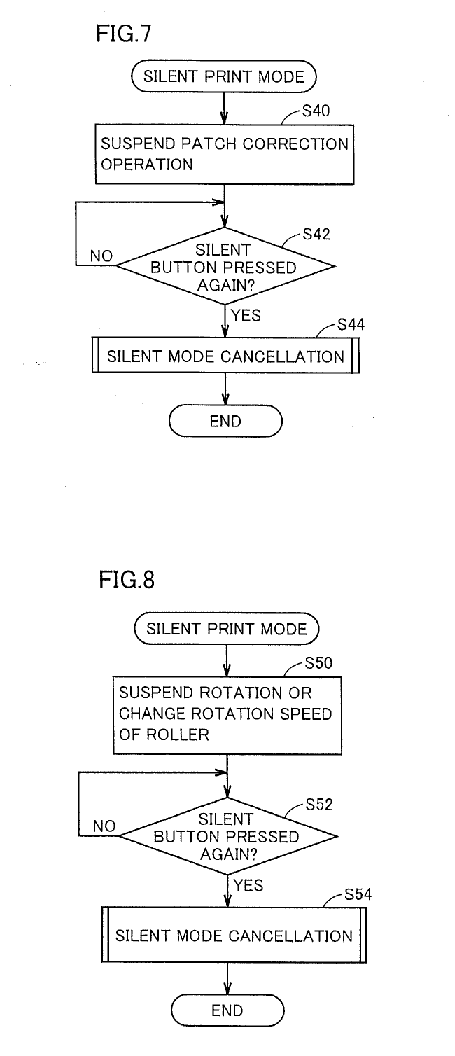

FIG. 7 is a flowchart representing the silent print mode in accordance with the present embodiment. Specifically, the mode is realized by control unit 50 reading a program stored in memory 70. Here, a process at image forming unit 10 as one of the plurality of moving parts will be described.

Referring to FIG. 7, control unit 50 suspends the patch correction operation in patch correction unit 106 of image forming unit 10 (step S40). As described above, patch correction unit 106 generates a pattern for detecting toner density, detects the generated pattern, and adjusts toner density. The patch correction operation is executed at a constant time interval or after the end of printing a prescribed number of sheets. Here, if the silent print mode is entered, control unit 50 suspends the process of patch correction unit 106 executing the patch correcting operation.

Next, control unit 50 determines whether or not silent button 214 is pressed again (step S42).

If it is determined at step S42 that silent button 214 is pressed again, suspension of the patch correction operation is cancelled and the silent mode is cancelled (step S44). The contents of the process for cancelling the silent mode will be described later. Then, the process ends (END).

In the silent print mode, by suspending, for example, the patch operation in image forming unit 10, the correcting operation of image forming unit 10 as the source of noise at the time of printing is temporarily stopped, so that the volume of operation noise is reduced and silent state is attained. Though an example of suspending the patch correcting operation in the silent print mode has been described above, the patch correcting operation is also executed at a prescribed time interval in the standby state. Therefore, similar process may be executed also in the silent standby mode.

(Modification 1)

FIG. 8 is another flowchart representing the silent print mode in accordance with the present embodiment. Specifically, the mode is realized by control unit 50 reading a program stored in memory 70. Here, a process at image forming unit 10 as one of the plurality of moving parts will be described.

Referring to FIG. 8, control unit 50 suspends rotation or changes the speed of rotation of rollers controlled by roller drive control unit 102 (step S50). As described above, roller drive control unit 102 executes, for example, feeding of recording paper. Here, if the silent print mode is entered, control unit 50 stops rotation of rollers controlled by roller drive control unit 102, or changes the speed of rotation of rollers controlled by roller drive control unit 102. For instance, the speed of rotation is decreased.

Next, control unit 50 determines whether or not silent button 214 is pressed again (step S52).

If it is determined at step S52 that silent button 214 is pressed again, suspension of the rotation of rollers or the change of speed of rotation is cancelled and the silent mode is cancelled (step S54). The contents of the process for cancelling the silent mode will be described later. Then, the process ends (END).

In the silent print mode, by suspending, for example, the rotation of rollers controlled by roller drive control unit 102 in image forming unit 10, the operation of feeding the recording paper in image forming unit 10 as the source of noise at the time of printing is immediately stopped, so that the volume of operation noise is reduced and silent state is attained. It is still possible, not by stopping driving of rollers but by decreasing the speed of rotation to feed the recording paper, to reduce the operation noise and to attain the silent state.

(Modification 2)

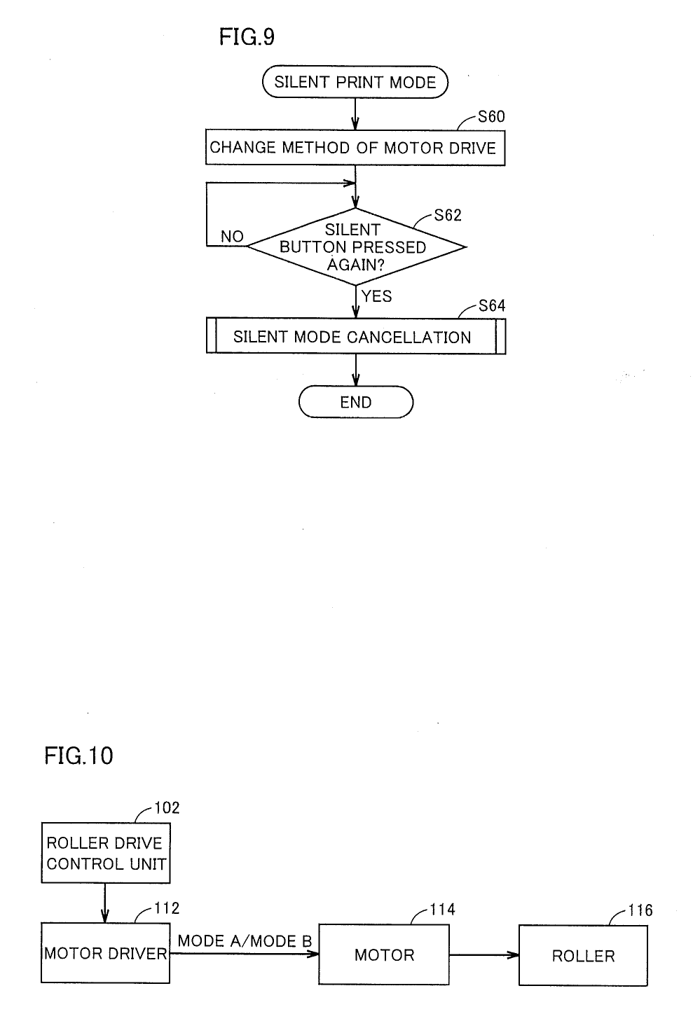

FIG. 9 is a still another flowchart illustrating the silent print mode in accordance with the present embodiment. Specifically, the mode is realized by control unit 50 reading a program stored in memory 70. Here, a process at image forming unit 10 as one of the plurality of moving parts will be described.

Referring to FIG. 9, control unit 50 changes the method of motor drive of roller drive control unit 102 in image forming unit 10 (step S60).

FIG. 10 is a control block for controlling rollers, in accordance with the present embodiment.

Referring to FIG. 10, roller drive control unit 102 controls a motor driver 112. Motor driver 112 controls a motor 114 for driving a roller.

In the present example, motor driver 112 has two modes (mode A/mode B), and drives motor 114 with its angle of rotation controlled in either one of the modes. Here, it is assumed that in mode A, motor 114 is controlled with the rotation angle of, for example, 1.8 degrees at a time. On the other hand, in mode B, it is assumed that motor 114 is controlled with the rotation angle of, for example, 0.9 degrees at a time. In accordance with an instruction from roller drive control unit 102, motor driver 112 normally controls the rotation angle of motor 114 in mode A. In accordance with an instruction from roller drive control unit 102, motor driver 112 controls the rotation angle of motor 114 in mode B in the silent print mode.

Again referring to FIG. 9, next, control unit 50 determines whether or not silent button 214 is pressed again (step S62).

If it is determined at step S62 that silent button 214 is pressed again, the process for cancelling the silent mode is executed (step S64). The contents of the process for cancelling the silent mode will be described later. Then, the process ends (END).

In the silent print mode, by changing, for example, the motor driving mode by motor driver 112 from mode A to mode B, it becomes possible to finely adjust the angle of rotation of the motor and, hence, the volume of noise in rotation control can be reduced and the silent state can be attained.

When the silent mode is cancelled, the driving mode for driving motor 114 by motor driver 112 is again changed, from mode B to mode A.

(Modification 3)

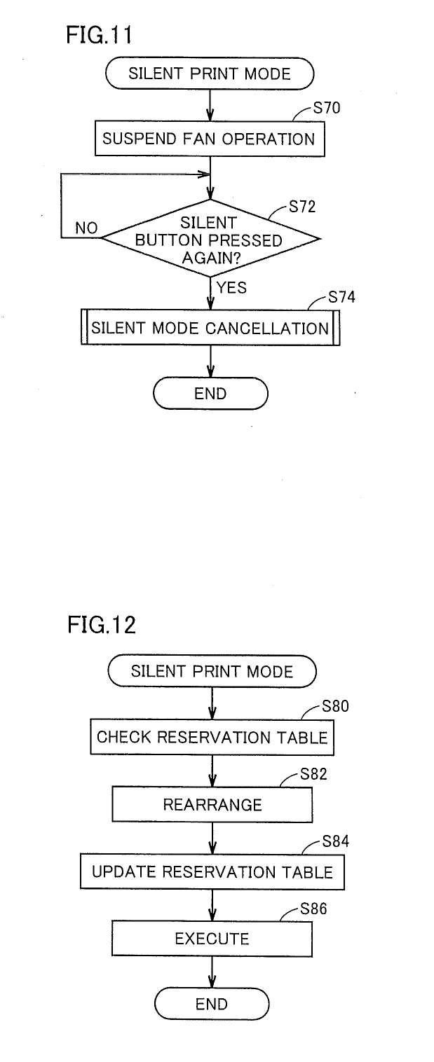

FIG. 11 is a still further flowchart representing the silent print mode in accordance with the present embodiment. Specifically, the mode is realized by control unit 50 reading a program stored in memory 70. Here, a process at internal fan 300 as one of the plurality of moving parts will be described.

Referring to FIG. 11, operation of the fan is suspended (step S70). By way of example, control unit 50 instructs internal fan control unit 52 for controlling internal fan 300 to stop operation of internal fan 300.

Next, control unit 50 determines whether or not silent button 214 is pressed again (step S72).

If it is determined at step S72 that silent button 214 is pressed again, suspension of the fan operation at step S70 is cancelled, and the silent mode is cancelled (step S74). The contents of the process for cancelling the silent mode will be described later. Then, the process ends (END).

In the silent print mode, by control unit 50 instructing internal fun control unit 52 to suspend rotation of internal fan 300, rotation of internal fan 300 as the source of noise at the time of printing is immediately stopped, so that the volume of operation noise is reduced and silent state is attained.

Further, the following control may be combined with suspension of operation of internal fan 300. For instance, even when the operation of internal fan 300 is suspended, too much increase of temperature in the apparatus should be avoided and, therefore, printing may be controlled such that a job of forming an image at a lower temperate in image forming unit 10 is printed with higher priority.

(Modification 4)

FIG. 12 is a still further flowchart representing the silent print mode in accordance with the present embodiment. Specifically, the mode is realized by control unit 50 reading a program stored in memory 70. Here, a process related to print reservation will be described as an example.

Referring to FIG. 12, control unit 50 refers to a reservation table (step S80). Specifically, the control unit checks the reservation table storing reserved jobs stored in memory 70.

Then, the jobs stored in the reservation table are rearranged (step S82).

Next, the reservation table is updated in accordance with the rearranged jobs (step S84).

Then, in accordance with the updated reservation table, the jobs are executed (step S86).

Then, the process ends (END).

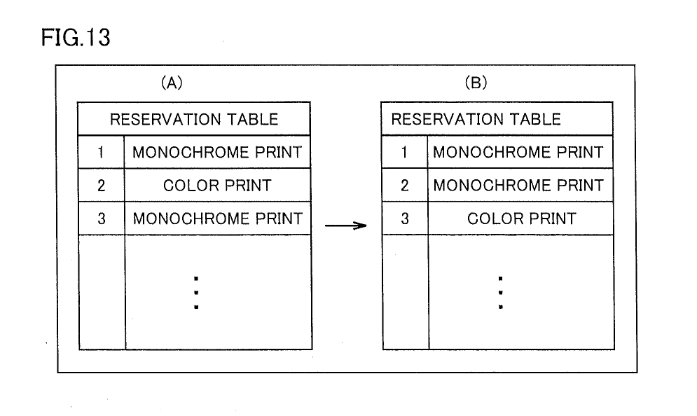

FIG. 13 shows updating of the reservation table in accordance with the present embodiment.

FIG. 13 shows an example in which three jobs are stored in the reservation table, as shown at (A). Specifically, the first job is a monochrome print, and the next job is a color print. The next job is a monochrome print.

By the rearrangement of jobs described above, the jobs are rearranged with monochrome print jobs given higher priority. Thus, the reservation table 13 is updated as shown at (B) of FIG. 13.

For a monochrome print, it is possible to form an image with relatively low fixing temperature as compared with a color print. Therefore, even when the operation of internal fan 300 is stopped, undesirable influence to the image forming apparatus as a whole can be prevented by executing monochrome prints with higher priority.

Though internal fan 300 has been described in the present example, a plurality of fans are provided in image forming apparatus 100, including, for instance, a fan for discharging ozone, a fan provided in fixing unit 40, and a fan provided for a power source. Rotation of one of or all of these fans may be stopped.

Though the jobs are rearranged depending on whether the job is monochrome print or color print in the foregoing, the jobs may be classified using scores representing how much the job contributes to attaining silence, and rearranged accordingly.

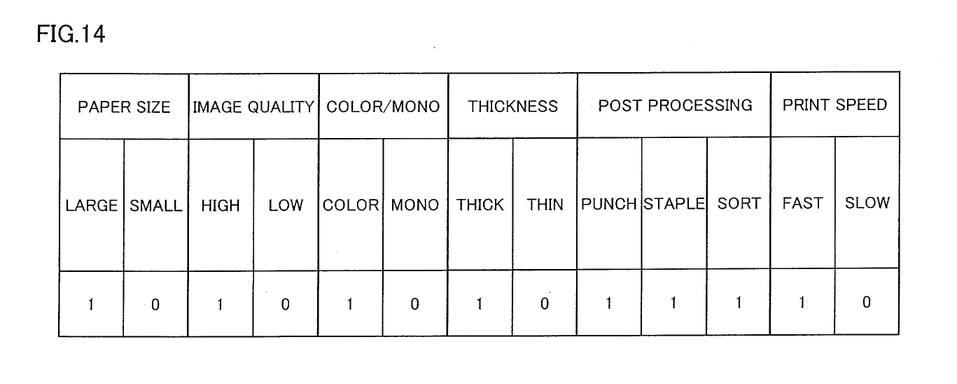

FIG. 14 shows the ranking table representing scores based on job types.

Referring to FIG. 14, here, a table is shown in which paper size, image quality, color/monochrome and thickness are each classified into two types, and of the two types, one causing larger noise gets higher score.

Specifically, if paper size is large (for example, B4 or larger), score 1 is given, and if the size is small (for example, smaller than B4), score 0 is given. Regarding image quality, score 1 is given to high image quality (for example, 400 dpi (dot per inch) or higher), and score 0 is given to low image quality (for example, lower than 400 dpi). Further, score 1 is given to color print, and score 0 is given to monochrome print. Regarding paper thickness, score 1 is given to a thick sheet and score 0 is given to a thin sheet. Further, score 1 is given every time one post processing operation is done. Assuming that three post processing operations of “punching,” “staple” and “sort” can be carried out independent from each other, score 1 is given if one of these three processing operations is executed, score 2 is given if two are executed, score 3 is given if three are executed, and score 0 is given if none of these is executed.

Control unit 50 sums the scores for each job in accordance with the contents of the job, with reference to the ranking table.

By way of example, if the job is for printing on a large size paper, with high image quality, in color, on a thick sheet with sorting only as the post processing, at a slow print speed, the score is 5.

On the other hand, if the job is for printing on a small size paper, with low image quality, in monochrome, on a thin sheet without executing any post processing at a slow print speed, the score is 0.

At step S82, in order of score, the jobs are rearranged, starting from one having lower score.

A job of lower score is considered to be a job that contributes more to silencing, or a job that generates smaller operation noise when executed. The reason for this is as follows. When the items of FIG. 14 are considered from the viewpoint of operation noise, if the paper size is smaller, the paper is thinner and the speed of printing becomes slower, the noise generated when the sheet of paper is fed in image forming apparatus 100 becomes smaller, the fixing temperature in fixing unit 40 can be set lower, so that the number of rotations of internal fan 300 can be set lower, and thus, the noise generated by the rotation of fan can be reduced. Further, the fixing temperature at fixing unit 40 can be set lower for a monochrome print than a color print and, therefore, the number of rotations of internal fan 300 can be set lower and thus, the noise generated by the rotation of fan can be reduced. Since noise generates in post processing operation, the noise can be reduced if the number of post processing operations is smaller. Further, if the image quality is low, ratio of printing (the ratio of area to which toner is transferred to the printable area of the sheet) of the sheet of paper used for image formation becomes lower, so that the fixing temperature in fixing unit 40 can be set lower and the number of rotations of internal fan 300 can be set lower. Whether the image quality is high or low can be determined from the object of printing. Specifically, if the object is text image, the image quality is determined to be low, and if it is photograph image, the image quality is determined to be high.

By this process, jobs that contribute to silencing are classified and, by executing jobs that contribute more to attaining silence with higher priority, the operation noise can be reduced and silent state can be attained.

If contents of each job are changeable to attain silence, the set contents are changed to reduce noise as much as possible. Specifically, if the speed of printing is set to “high” for a job and if it is possible to change the setting to “low” (or if there is no information registered to inhibit change of setting of the print speed), the print speed is changed from “high” to “low” and then, the scores are summed in accordance with the ranking table described above.

(Modification 5)

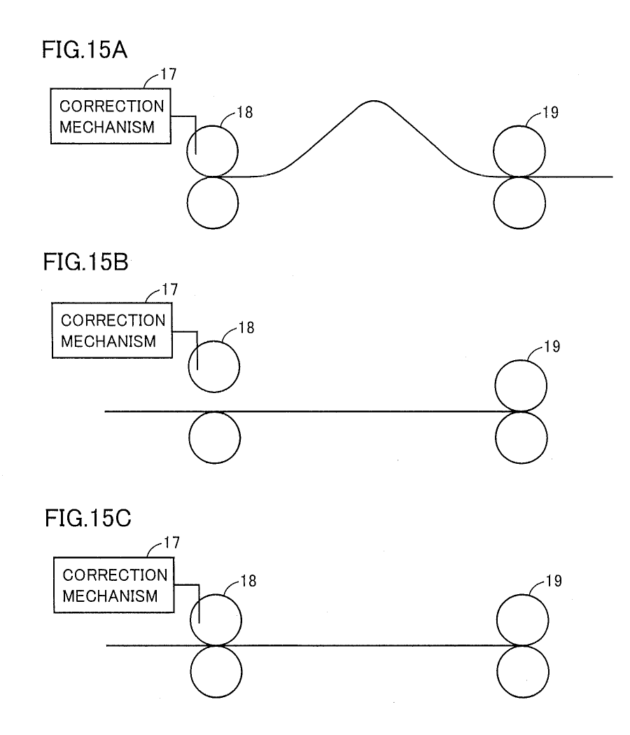

FIGS. 15A to 15C illustrate control of a correction roller for correcting deviation of sheet such as paper skew, in accordance with an embodiment of the present invention.

FIG. 15A shows an example including a correction roller 18 for correcting deviation such as paper skew and a timing roller 19 for feeding the sheet of paper to correction roller 18 at a prescribed timing.

Referring to FIG. 15A, a correction mechanism 17 for adjusting position is provided for correction roller 18, and correction mechanism 17 is capable of moving correction roller 18 away from an opposed roller. Correction mechanism 17 operates in accordance with an instruction from a deviation correction unit 104.

Further, correction mechanism 17 is capable of stopping rotation of correction roller 18 to stop feeding of recording paper.

In this state, when a sheet of recording paper is fed by timing roller 19 to correction roller 18, the sheet of recording paper abuts correction roller 18 and the sheet is deflected.

Then, as shown in FIG. 15B, the position of correction roller 18 is adjusted by correction mechanism 17 to be separated from the opposed roller, so that the deflection is eliminated and the deviation such as paper skew can be corrected.

When the deflection is eliminated, the sound of paper rubbing may be a source of noise.

In the present example, as shown in FIG. 15C, formation of deflection and elimination of deflection of the recording paper by correction mechanism 17 are not executed but the sheet from timing roller 19 is fed by rotating correction roller 18, whereby the rubbing sound of paper can be prevented and the noise is reduced.

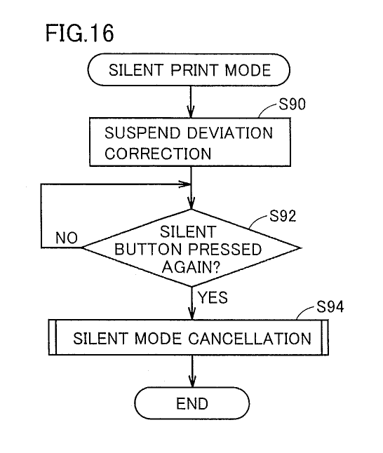

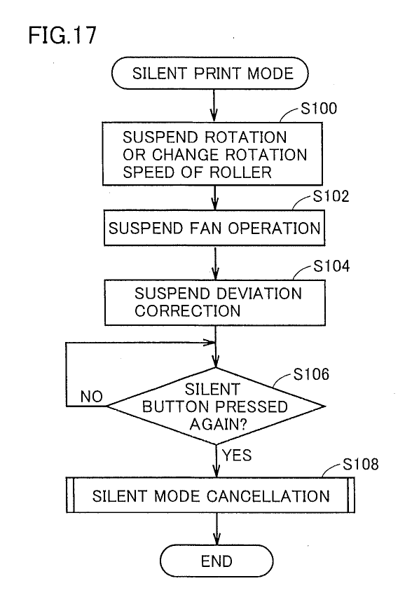

FIG. 16 is a still further flowchart representing the silent print mode in accordance with the present embodiment. Specifically, the mode is realized by control unit 50 reading a program stored in memory 70. Here, a process at a deviation correction unit 104 of image forming unit 10 as an example of a plurality of moving parts will be described.

Referring to FIG. 16, the deviation correction is suspended (step S90). As described above, control unit 50 instructs, as an example, deviation correction unit 104 to stop deviation correction.

Next, control unit 50 determines whether or not silent button 214 is pressed again (step S92).

If it is determined at step S92 that silent button 214 is pressed again, suspension of the deviation correction is cancelled and the silent mode is cancelled (step S94). The contents of the process for cancelling the silent mode will be described later. Then, the process ends (END).

In the silent print mode, by way of example, the control unit 50 instructs deviation correction unit 104 to suspend deviation correction and, in addition, suspends the rotation of internal fan 300 for cooling correction roller 18. As a result, rotation of internal fan 300 as the source of noise at the time of printing is immediately stopped, so that the volume of operation noise is reduced and silent state is attained.

In the foregoing, processes executed when an input is given through silent button 214 of operation display 200 as the input unit have been described. These processes, however, are not limiting and, by way of example, the process to make a transition to the silent mode may be executed in response to a prescribed voice input, using collector microphone 204.

Further, control may be done such that, using authentication sensor 208, only an input of silent button by a successfully authenticated user is accepted. Alternatively, control may be done such that, by displaying an authentication screen image on display unit 212 of operation display 200 to have the user execute the authentication process, rather than using authentication sensor 208, only an input of silent button by a successfully authenticated user is accepted. The input may not be limited to the input from silent button 214 on operation display 200. By way of example, a button of similar function to silent button 214 may be provided, for example, on a remote controller, pressing of the function button provided on the external remote controller may be detected by control unit 50, and the operation may enter the silent mode. Alternatively, the silent mode may be entered in response to an external input from a terminal connected through a network to image forming apparatus 100. By way of example, a button of similar function to the silent button may be displayed on a display of the terminal, and control unit 50 of image forming apparatus 100 may detect whether or not there is an input (designation) of the function button.

(Modification 6)

FIG. 17 is a still further flowchart representing the silent print mode in accordance with the present embodiment.

In the silent print mode in accordance with the present modification, among the control contents suspended in the silent print mode and its modifications described with reference to FIGS. 7 to 16, two or more of the contents are suspended.

In the present modification, when the silent print mode is entered, control unit 50 suspends rotation or changes speed of rotation of rollers controlled by roller drive control unit 102, in image forming unit 10 at step S100.

Next, at step S102, control unit 50 suspends the operation of fan, in the similar manner as at step S70.

Next, at step S104, control unit 50 suspends deviation correction, in the similar manner as at step S90.

Next, at step S106, control unit 50 determines whether or not silent button 214 is pressed again.

If it is determined at step S106 that silent button 214 is pressed again, suspension of the rotation of rollers or the change of speed of rotation is cancelled, suspension of fan operation is cancelled, suspension of deviation correction is cancelled, and thereby the silent mode is cancelled (step S108). The contents of the process for cancelling the silent mode will be described later. Then, the process ends (END).

[8. Silent Mode Cancellation]

In the present embodiment, when each of the silent modes (silent activation mode, silent print mode and silent standby mode) is cancelled (step S28 etc.) in the silent mode processes (FIGS. 5 to 9, 11, 16, 17), the silent mode is cancelled stepwise. Therefore, in image forming apparatus 100, the volume of noise increases not abruptly but stepwise from the noise reduced state. In the following, contents of the process for cancelling silent mode will be described.

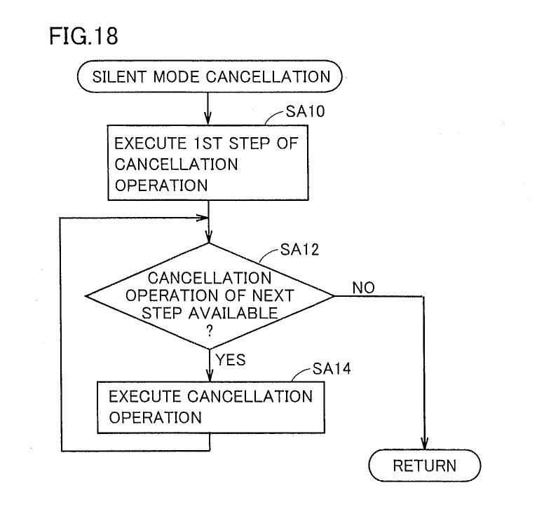

FIG. 18 is a flowchart of a sub-routine representing a process for cancelling the silent mode (silent mode cancellation process) at steps S28, S38, S44, S54, S64, S74, S94 and S108 of FIG. 5.

Referring to FIG. 18, if it is determined at step S26 or at other steps that silent button 214 is pressed again, control unit 50 executes, at step SA10, an operation of cancelling the operation for reducing noise effected at step S20 or at other steps. It is noted that at step SA10, the cancellation operation is not fully executed in one step but the cancellation operation includes a plurality of steps, and the steps are executed one by one.

Thereafter, at step SA12, control unit 50 determines whether or not there is any step of cancellation operation not yet executed among the plurality of steps of cancellation operation. If the determination is positive, the process proceeds to step SA14, and if not, the process returns to each silent mode. In the process of each of the silent modes shown in FIGS. 5 to 9, 11, 16 and 17, if there is a return from the process for cancelling silent mode shown in FIG. 18, the control returns to step S4 of FIG. 4. Therefore, if each silent mode is cancelled and silent button 214 is pressed thereafter, the operation of image forming apparatus 100 enters the silent mode (silent activation mode, silent print mode or silent standby mode) in accordance with the state of image forming apparatus 100 at the time when the button is pressed.

At step SA14, control unit 50 executes the cancellation operation of the step next to the presently executed cancellation operation, and returns the process to step SA12.

Specific contents of the process for cancelling the silent mode described above are as follows.

By way of example, referring to FIG. 5 or 6, rotation of fixing roller 312 at fixing unit 40 is suspended to attain silence. In this case, control unit 50 restarts rotation of fixing roller 312 at step SA10. It is noted that the speed of rotation of fixing roller 312 is not increased at one time to the speed of rotation N before suspension. First, the speed of rotation of fixing roller 312 is increased to a speed of rotation N1 lower than speed of rotation N. More specifically, the speed of rotation of fixing roller 312 is increased in a manner stored in memory 70. Memory 70 stores numbers of rotations N1 to Nm of each turn if step S10 is executed once and step S14 is executed repeatedly for (m−1) times. Here, Nm is the speed of rotation N before suspension. Control unit 50 increases the speed of rotation of fixing roller 312 to N1 at the first execution of step SA10, to N2 at the first execution of step SA14, and step SA14 is successively repeated, until the speed of rotation of fixing roller 312 reaches Nm (=N) at the (m−1)-th execution of step SA14. Then, the process is returned.

In the process of returning the operation suspended for attaining silence to the state before entering the silent mode in a plurality of steps described with reference to FIG. 18, it is preferred that, when each step of the process for cancellation is executed, execution of the next step starts after the lapse of a prescribed time period. More specifically, after the execution of step SA10, or after the execution of step SA14, it is preferred that the next execution of step SA14 starts after the lapse of a prescribed time period.

Further, in the process shown in FIG. 18, the speed of rotation of a feed roller of which rotation has been stopped or the speed of rotation has been decreased for attaining silence as shown in FIG. 8 is also increased stepwise, in the similar manner as fixing roller 312 described above. The increase/decrease of the speed of rotation of feed roller corresponds to the increase/decrease of paper feeding speed in image forming apparatus 100. Further, the increase/decrease of the speed of rotation of feed roller corresponds to the increase/decrease of the number of sheets discharged per unit time from image forming apparatus 100 to discharge tray 23. Here, if a polygon mirror is used for forming an image on the photoreceptor, in order to change the speed of paper feeding without changing the speed of rotation of the polygon mirror, it is preferred that the speed of rotation of feed roller is increased gradually by 12.5%, 25%, 50% and 100%.

Further, in the process of FIG. 18, the number of rotations of internal fun 300 of which rotation has been suspended for attaining silence as shown in FIG. 11 is also increased stepwise, similar to the speed of operation of fixing roller 312 described above.

(Modification 1)

If operations of a plurality of elements have been suspended for attaining silence in the silence mode, the volume of operation noise may be increased stepwise by cancelling suspension of operations of various elements one by one successively, in the process of cancelling the silence mode.

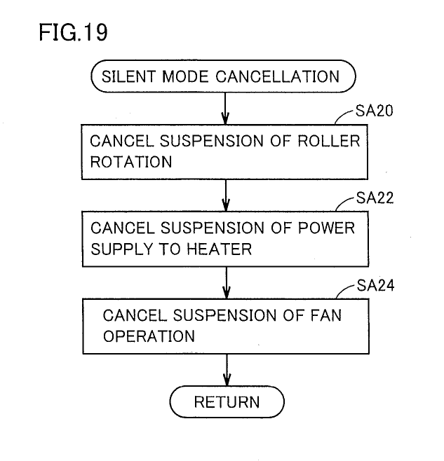

FIG. 19 is a flowchart representing a modification of the process shown in FIG. 18. FIG. 19 is a flowchart of the process corresponding to the process of silent standby mode shown in FIG. 6. Specifically, in FIG. 19, fixing roller 312, heater 314 and fan 310 are described as examples of the plurality of elements.

Referring to FIG. 19, if it is determined at step S36 that silent button 214 is pressed again, at step SA20, control unit 50 cancels suspension of rotation (restarts rotation) of fixing roller 312, and the process proceeds to step SA22.

At step SA22, control unit 50 restarts power supply to heater 314, and the process proceeds to step SA24.

At step SA24, control unit 50 cancels suspension of rotation (restarts rotation) of fan 310, and the process returns to FIG. 6.

It is preferred that step SA22 is executed on condition that a prescribed time period has passed after the completion of the process at step SA20. Further, it is preferred that step SA24 is executed on condition that a prescribed time period has passed after the completion of the process at step SA22.

Further, at step SA20, the speed of rotation of fixing roller 312 may be increased stepwise every time a prescribed time period passes. Further, at step SA24, the speed of rotation of fan 310 may be increased stepwise every time a prescribed time period passes.

(Modification 2)

In each of the silent modes described with reference to FIGS. 7 and 9, for further noise reduction, the speed of rotation of feed roller may be decreased and the speed of paper feed may be reduced.

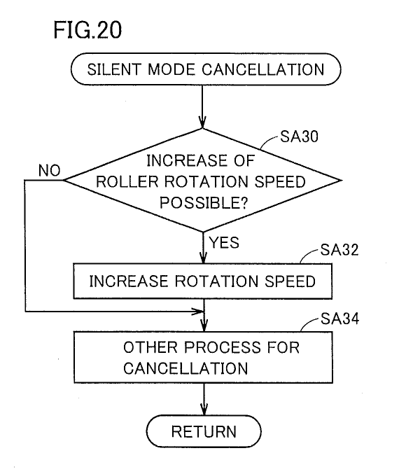

In such a case, in the process of cancelling silent mode at step S44 or S64, suspension of the patch correction operation is cancelled, or the driving mode of motor 114 is changed from mode B to mode A, and the speed of rotation of the feed roller is increased (returned). FIG. 20 is a flowchart of a subroutine representing the silent mode cancelling process in accordance with the present modification.

Referring to FIG. 20, in the silent mode cancelling process in accordance with the present modification, at step SA30, control unit 50 determines whether or not the speed of rotation of feed roller can be increased. If it is determined to be possible, at step SA32, the speed of rotation of feed roller is increased to the speed of rotation before the transition to silent mode, and the control proceeds to step SA34. On the other hand, if it is determined at step SA30 that the speed of rotation cannot be increased, the process of control unit 50 directly proceeds to step SA34. A situation in which the speed of rotation cannot be increased is, for example, when the speed of rotation of feed roller has not been decreased at the transition to the silent mode.

At step SA34, control unit 50 executes other process for cancelling the silent mode (suspension of the patch correction operation is cancelled, or the driving mode of motor 114 is changed from mode B to mode A), and the process returns to FIG. 7 or FIG. 9.

(Modification 3)

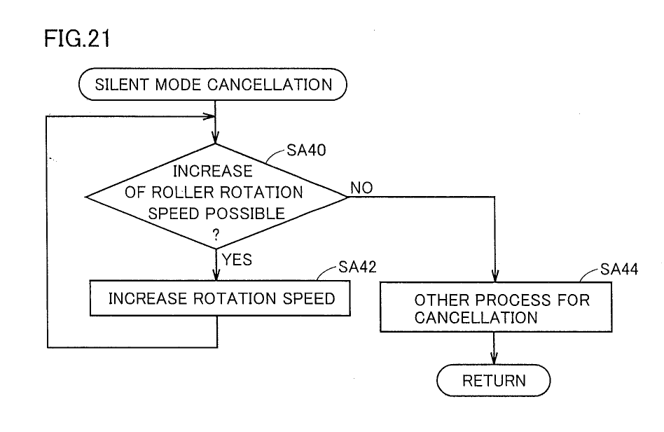

In the modification of FIG. 20, it is possible to increase the speed of rotation of feed roller in a plurality of steps. FIG. 21 is a flowchart of a subroutine representing the silent mode cancelling process in accordance with a modification of FIG. 20.

Referring to FIG. 21, in the silent mode cancelling process in accordance with the present modification, at step SA40, control unit 50 determines whether or not it is possible to further increase the speed of rotation of feed roller. If the speed of rotation of feed roller has not yet been returned to the speed before the transition to the silent mode, control unit 50 determines that further increase of the speed is possible, and the process proceeds to step SA42. If it is determined that the speed has already returned to the speed before transition to the silent mode, the process by control unit 50 proceeds to step SA44.

At step SA42, control unit 50 increases the speed of rotation of feed roller by one step, and the process returns to step S40.

At step SA44, control unit 50 executes other process for cancelling the silent mode (suspension of the patch correction operation is cancelled, or the driving mode of motor 114 is changed from mode B to mode A), and the process returns to FIG. 7 or FIG. 9.

(Modification 4)

When the silent print mode (FIGS. 7 to 17) is cancelled, control unit 50 may estimate or expect, for each of the jobs to be executed thereafter, the operation noise caused when the job is executed, and may execute the jobs in order of expected driving noise, starting from the one with the smallest expected noise. In this manner, the volume of operation noise can be increased stepwise while the process for cancelling the silent mode is being executed.

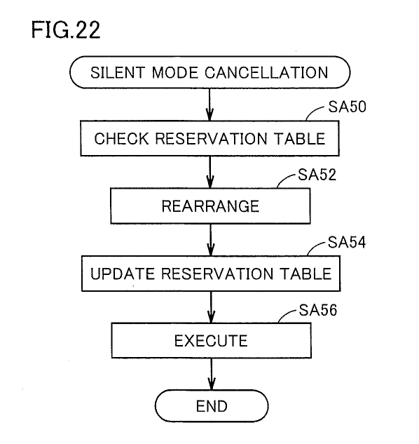

FIG. 22 is a flowchart of a subroutine representing the silent mode cancelling process in accordance with the present modification.

Referring to FIG. 22, in the silent mode cancelling process, control unit 50 first refers to the reservation table at step SA50. Specifically, it confirms the reservation table storing reserved jobs, currently stored in memory 70. Thereafter, at step SA52, the jobs stored in the reservation table are rearranged. Thereafter, at step SA54, the reservation table is updated in accordance with the rearranged jobs. Then, at step SA56, the jobs are executed in accordance with the order of the updated reservation table, and the silent mode cancelling process ends.

Here, the update of reservation table may be doe in the similar manner as the update of reservation table described with reference to FIG. 13. Further, in the rearrangement of jobs stored in the reservation table, by way of example, scores may be given to each of the jobs as described with reference to FIG. 14 and the arrangement may be changed such that jobs are executed in order of scores starting from the lowest one, that is, starting from the job of which expected operation noise at the time of execution is the lowest. In this example, job-by-job calculation of scores corresponds to the job-by-job estimation of operation noise.

In place of calculation of scores corresponding to the operation noise, expected volume of noise may be calculated. Specifically, the volume of noise expected when each element of image forming apparatus 100 operates is stored in advance in memory 70. Further, the volume of noise expected when a sheet is fed in image forming apparatus 100 is also stored in advance in memory 70. Then, elements of image forming apparatus 100 that are to be operated in executing each job are selected, volumes of noise stored for the selected elements are summed, and the noise volume for paper feed is added to the sum. Thus, the volume of noise expected for each job can be calculated.

In the process for cancelling the silent mode, jobs may be executed starting from the one of the lowest expected volume of noise, while the number of rotations of fans and the number of rotations of a motor may be increased stepwise.

[9. Other Modifications]

In the embodiment described above, transition to various silent modes and the cancellation of the silent modes are instructed by the user by pressing silent button 214, and in response, the instruction is input to control unit 50. The instructions of transition and cancellation to control unit 50 of image forming apparatus 100 may be input in different manner. By way of example, where a timer is set for the transition and/or cancellation, if the set time is reached, control unit 50 executes the process shown in various figures above, assuming that the instruction of transition and/or cancellation is input. The timer may be set based on information input to input unit 60. Alternatively, image forming apparatus 100 may be provided with a communication function, and the timer may be set based on information received through a network by the communication function. The information related to timer setting (such as the time to make a transition to the silent mode) is stored in memory 70. In this case, control unit 50 also serves as input means.

According to the embodiment described above, in the image forming apparatus, when an instruction to enter the silent mode is input, operation noise of moving parts is reduced. When an instruction to cancel the silent mode is input, the image forming apparatus returns to the state before the instruction to enter the silent mode, with the operation noise of moving parts increased stepwise.

Specifically, at the transition to the silent mode, the operation noise is reduced at once. On the other hand, at the return from the silent mode to the original state before transition, the operation noise increases stepwise.

Therefore, the image forming apparatus can execute operations with the volume of operation noise reduced immediately, and when the operation returns to the original volume of operation noise, abrupt increase of operation noise, which may be uncomfortable to the user, can be avoided.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus having a moving part operating for forming an image on a sheet of recording paper, comprising:
an input unit giving an instruction to make a transition to a silent mode having operation noise by said moving part reduced, and an instruction to cancel said silent mode; and
a control unit controlling operation of said moving part; wherein
said control unit executes, in response to an instruction to make a transition to said silent mode input from said input unit, first control of reducing operation noise of said moving part, and
in response to an instruction to cancel said silent mode input from said input unit, executes second control of returning state of operation of said moving part to a state before the first control, with operation noise of said moving part increased stepwise.

2. The image forming apparatus according to claim 1, wherein
said moving parts discharges recording paper having images formed thereon; and
said control unit executes said first control by decreasing amount of discharge per unit time of said recording paper by said moving part.

3. The image forming apparatus according to claim 2, wherein
said moving part executes jobs; and
in said second control, said control unit estimates, for each of a plurality of jobs executed by said moving part, volume of operation noise generated by said moving part when executing the job, and causes said moving part to execute jobs in order, starting from a job of which estimated operation noise is the smallest.

4. The image forming apparatus according to claim 3, further comprising
a storage unit for storing, for each setting item of a job, an index of volume of operation noise of said moving part in accordance with set contents; wherein
said control unit obtains, for each of said plurality of jobs, said index corresponding to the set contents of each job, and by calculating a sum of obtained indexes, estimates volume of operation noise of said moving part.

5. The image forming apparatus according to claim 3, wherein
said moving part executes a post processing operation on recording paper having images formed thereon; and
said index comes to have a value indicating larger operation noise of said moving part when said set contents corresponding to the index includes said post processing operation than when not.

6. The image forming apparatus according to claim 3, wherein
said moving part has a fan for circulating air in said image forming apparatus, and a fixing unit for fixing an image formed on a sheet of recording paper on the sheet;
said storage unit stores said index for first setting contents and said index for second setting contents, respectively;
said first setting contents include fixing temperature of said fixing unit higher and speed of rotation of said fan higher than said second setting contents; and
said index corresponding to said first setting contents has a value indicating larger volume of operation noise of said moving part than said index corresponding to said second setting contents.

7. The image forming apparatus according to claim 1, wherein
in response to an input of instruction to cancel said silent mode, said control unit controls said moving part such that operation noise of said moving part increases stepwise to a state of operation before said transition, at every prescribed time interval, at every image formation on a sheet of recording paper, at every image formation of one job, or every time a predetermined condition is satisfied.
